(19) United States
(12) Patent Application Publication
(10) Pub. No.: US 2009/0296005 A1
(43) Pub. Date: Dec. 3, 2009

(54) LUMINANCE CONTROL METHOD AND DEVICE

(75) Inventors: Tung-Min Li, Taoyuan (TW); Shen-Huei Wang, Taoyuan (TW); Hsin-Hsing Wu, Taoyuan (TW)

Correspondence Address: KIRTON AND MCCONKIE, 60 EAST SOUTH TEMPLE,, SUITE 1800, SALT LAKE CITY, UT, 84111, US

(73) Assignee: MATRITEK INC., Taoyuan (TW)

(21) Appl. No.: 12/186,687

(22) Filed: Aug. 6, 2008

(30) Foreign Application Priority Data
Jun. 2, 2008 (TW) 097120478

(51) Int. Cl. H04N 9/31

(52) U.S. Cl. 348/744; 348/E09.025

(57) ABSTRACT

The present invention provides a luminance control method and a luminance control device for use with a projection system having a light source and a color wheel. The luminance control device includes a processing module, a power supply unit and a lamp driver. The luminance control method includes steps of issuing a power control signal to define a plurality of time segments in a cycle period, wherein luminance messages composed of different numbers of pulses are included in respective time segments; reading out the luminance messages included in the respective time segments in receipt of the power control signal; and adjusting luminance values of the light emitted by the light source to be projected to the color wheel according to the luminance messages.

### FIELD OF THE INVENTION

The present invention relates to a luminance control method and a luminance control device, and more particularly to a luminance control method and a luminance control device for use with a projection system.

### BACKGROUND OF THE INVENTION

Recently, a digital projection and display system is commercially available from Texas Instruments Incorporated (TI) under the trademark Digital Light Processing® (also referred as DLP). The DLP digital projection and display system utilizes a digital micromirror device (DMD) in its optical path. The digital micromirror device (DMD) is fabricated according to a MEMS (Micro-Electro-Mechanical System) technology. Typically, the DMD includes a great amount of tiny digital light switches. The digital light switches are very small-sized micromirrors allowing for fast and precise rotation in receipt of electronic control signals. Each micromirror is a light switch that is capable of reflecting light in one of two directions. When the micromirror is in an “on” state, the incident light is reflected into the pupil of the projection lens and thus the micromirror appears bright in this “on” state. Whereas, when the micromirror is in an “off” state, the incident light is reflected out of the pupil of the projection lens and thus the micromirror appears dark in this “off” state.

Desired gray scales are achieved by using binary pulsewidth modulation to control the micromirrors. For example, a digital data of an 8-bit binary code may be converted into a pulse width of 256 discrete levels such that there are 256 bright-to-dark duration ratios for the micromirror. That is, this grayscale sets an image resolution of 256.

FIG. 1 is a simplified diagram illustrating a conventional DMD-type digital projection and display system. In the digital projection and display system of FIG. 1, a light beam emitted by a light source 10 is focused and shaped by a lens assembly 11 and then directed to a digital micromirror device (DMD) 12. The light beam is then selectively reflected from the digital micromirror device 12 to create a visual image on a screen 15 through a projection lens 14. In addition, a color wheel 13, which is arranged between the light source 10 and the digital micromirror device 12, is an essential component for displaying colorful images through the digital micromirror device 12. As the color wheel 13 rotates for a revolution in a unit time period, the light beam emitted by a light source 10 successively passes through different sections of the color wheel 13 such that different colors of light are projected onto the digital micromirror device 12 in different time segments. For example, if the color wheel 13 has four light-transmissive sections with different colors (e.g. white, red, green and blue sections), white, red, green and blue light beams are successively filtered by the color wheel 13 in different time segments of the unit time period and projected onto the digital micromirror device 12. By using the above stated binary pulsewidth modulation, different colors with different intensities may be adjusted in each time segment so as to mix a desired color.

Furthermore, the fractions of the color sections of the color wheel 13 have great influences on characteristics of the resulting color. That is, by designing different fractions of the color sections to make an angular allocation in a revolution (e.g. 360°) of the color wheel 13, a desired color is achieved. If only one parameter (e.g. the angular allocation) is utilized, the adjustable light colors are usually insufficient to comply with various scenarios. In addition, the angular allocation of the color wheel 13 usually fails to be modified and thus the flexibility of designing the color wheel is restricted.

Therefore, there is a need of providing a luminance control method and a luminance control device to obviate the drawbacks encountered from the prior art.

### SUMMARY OF THE INVENTION

In accordance with an embodiment of the present invention, there is provided a luminance control method for use with a projection system having a light source and a color wheel. The luminance control method includes steps of issuing a power control signal to define a plurality of time segments in a cycle period, wherein luminance messages composed of different numbers of pulses are included in respective time segments; reading out the luminance messages included in the respective time segments in receipt of the power control signal; and adjusting luminance values of the light emitted by the light source to be projected to the color wheel according to the luminance messages.

In accordance with another embodiment of the present invention, there is provided a luminance control device for use with a projection system having a light source and a color wheel. The luminance control device includes a processing module, a power supply unit and a lamp driver. The processing module issues a power control signal to define a plurality of time segments in a cycle period, wherein luminance messages composed of different numbers of pulses are included in respective time segments. The power supply unit is used for powering the light source. The lamp driver is electrically connected to the processing module and the power supply unit for reading out the luminance messages included in the respective time segments in receipt of the power control signal. The power levels to be outputted from the lamp driver to the light source are adjusted according to the luminance messages, thereby adjusting luminance values of the light emitted by the light source to be projected to the color wheel.

The luminance control method and the luminance control device of the embodiments of the present invention are capable of achieving various light colors in different scenarios by using a power control signal containing different numbers of pulses and different color sections of a color wheel.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a simplified diagram illustrating a conventional DMD-type digital projection and display system;

FIG. 2 is a schematic timing waveform diagram of a power control signal used in a luminance control method according to a preferred embodiment of the present invention;

FIG. 3 is a schematic block functional diagram illustrating a luminance control device of implementing the luminance control method as shown in FIG. 2;

FIG. 4 is a flowchart illustrating a luminance control method for use with a projection system according to a preferred embodiment of the present invention;

FIG. 5A is a look-up table correlating the light luminance levels to a set of relative power levels;

FIG. 5B is a look-up table correlating the color parameters of an exemplary color wheel to three scenarios;

FIG. 5C is a schematic timing waveform diagram illustrating the start control input (SCI) signals used in the scenarios 1, 2 and 3 as shown in FIG. 5B; and

FIG. 5D is a look-up table correlating the color parameters of another exemplary color wheel to various scenarios.

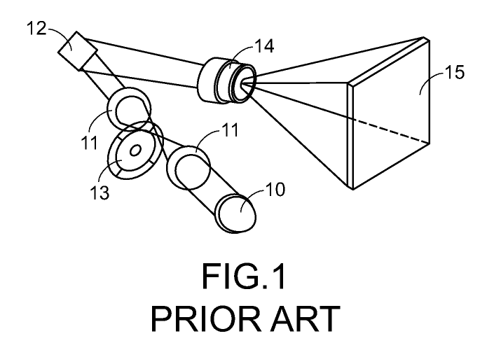

### DETAILED DESCRIPTION OF THE PREFERRED EMBODIMENT

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be located in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component directly or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

For obviating the drawbacks encountered from the prior art, the luminance control device of the present invention may adjust the power levels of a light source inside a projection system according to a power control signal. Consequently, the light emitted by the light source has different intensities in different time segments.

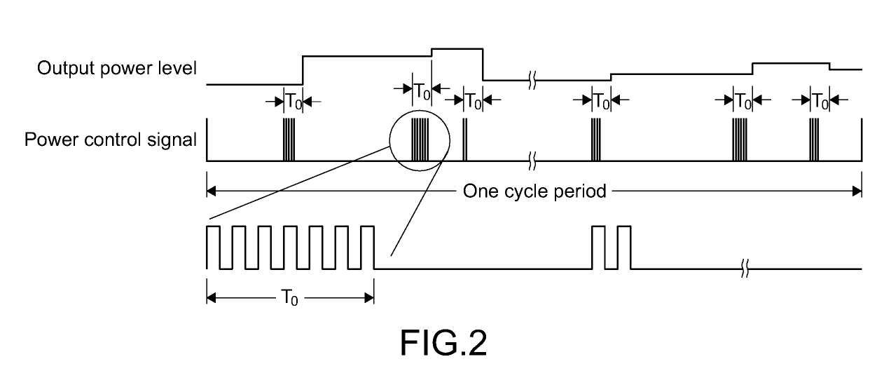

FIG. 2 is a schematic timing waveform diagram of a power control signal used in a luminance control method according to a preferred embodiment of the present invention. In every cycle period of the power control signal, N counts of time segments are defined. In this context, the cycle period is equal to the duration when the color wheel rotates for one revolution. The number and the duration of the time segments are dependent on the number and the angle allocations of the color sections in the color wheel. In a certain time interval TO of each time segment, a luminance message composed of different numbers of pulses is included. In other words, the power control signal contains different numbers of pulses to define the power levels to be outputted by a lamp driver in the next time segment. By reading out the pulse numbers during the certain time interval TO, the projection system is capable of realizing the magnitude of a corresponding power level to be outputted. As a result, the lamp driver is controlled to output the corresponding power level in the next time segment so as to adjust the light intensities in different time segments.

Take a color wheel having four color sections of white color (W), red color (R), green color (G) and blue color (B) for example. Each of the W, R, G and B sections has a fan-shaped area whose inner angle is 90 degree in relation to the rotation axis. It is certainly that the inner angles may be varied according to the manufacturer's design. In a case that four time segments are defined in one cycle period, the duration of each time segment is equal to one-fourth of the cycle period. In accordance with a key feature of the present invention, the numbers of pulses contained in the time interval T0 at the tail portion of a current time segment define the power level to be outputted by the lamp driver in the next time segment. As a result, the lamp driver is controlled to output the corresponding power level in the next time segment so as to adjust the light intensities in different time segments. In the other embodiments, the number of time segments is less than the number of color sections of the color wheel. Under this circumstance, the light intensities of different colors may be identical.

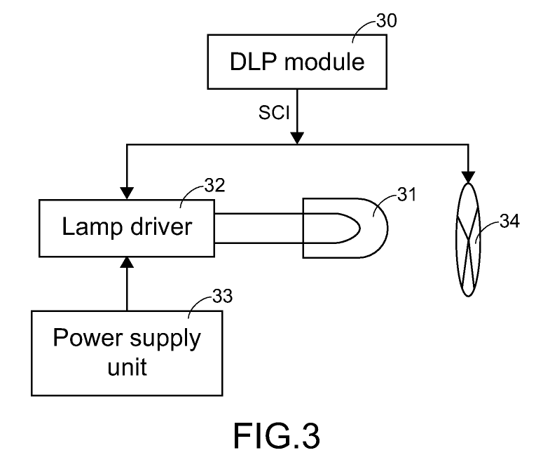

FIG. 3 is a schematic block functional diagram illustrating a luminance control device of implementing the luminance control method as shown in FIG. 2. The luminance control device includes a digital light processing (DLP) module 30, a lamp driver 32 and a power supply unit 33. In this embodiment, the power control signal is a start control input (SCI) signal originated from the DLP module 30 of the projection system. Conventionally, the SCI signal is an activating signal for turning on a light source 31 such as a high intensity discharge (HID) lamp. The SCI signal is transmitted to the lamp driver 32. In response to SCI signal, a powering signal required for powering the light source 31 is generated by the lamp driver 32. In addition, the SCI signal is a reference signal for assuring synchronization between all function components inside the projection system. After a step of encoding pulse numbers in the SCI signal, the DLP module 30 issued the processed SCI signal to the lamp driver 32 and the color wheel 34. Consequently, the lamp driver 32 is synchronous with the color wheel 34 according to the SCI signal. After the pulse numbers of the SCI signal are decoded by the lamp driver 32, the power supply unit 33 controls adjustment of the power watts to be outputted by the lamp driver 32 so that the light luminance is dynamically controlled. In synchronization with rotation of the color sections of the color wheel 34, the lamp driver 32 is controlled to output the corresponding power level in the next time segment so as to achieve desired light color.

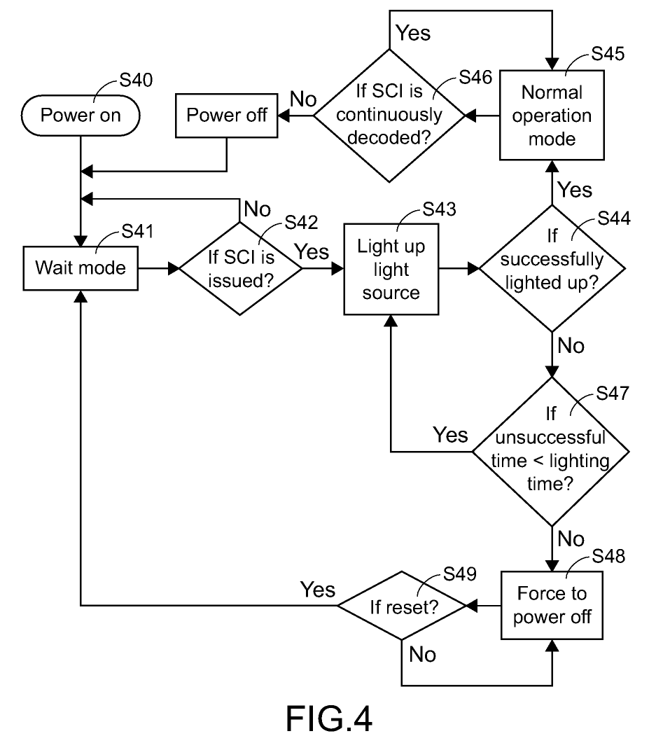

Hereinafter, a luminance control method for use with a projection system according to a preferred embodiment of the present invention will be illustrated with reference to a flowchart of FIG. 4. After the projection system is powered on (Step S40), the projection system is in a wait mode (Step S41). In the wait mode, if a SCI signal is issued (Step S42), the light source is turned on (Step S43). If the light source is successfully lighted up (Step S44), the projection system enters a normal operation mode (Step S45) and then the SCI signal is continuously decoded (Step S46). Meanwhile, the intensities of the light emitted by the light source are dynamically controlled. Whereas, if the light source is not successfully lighted up but the unsuccessful time is within a predetermined lighting time (Step S47), the light source is turned on again (Step S43). If the unsuccessful time is over the predetermined lighting time, the system is forced to power off (Step S48). Meanwhile, the user may decide whether the system is reset (Step S49).

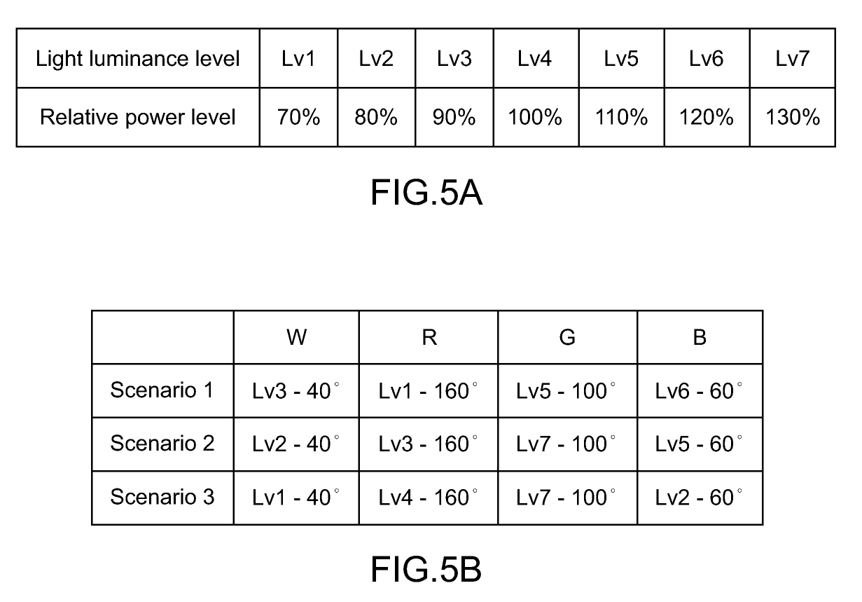

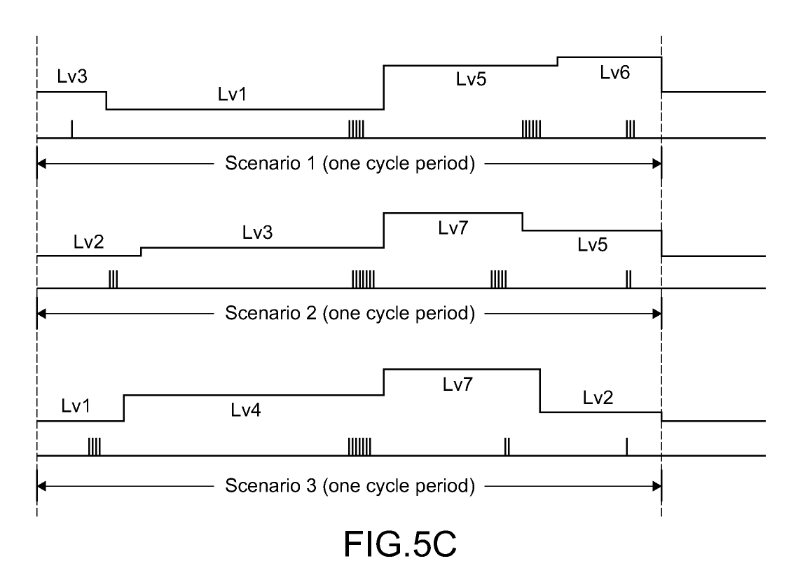

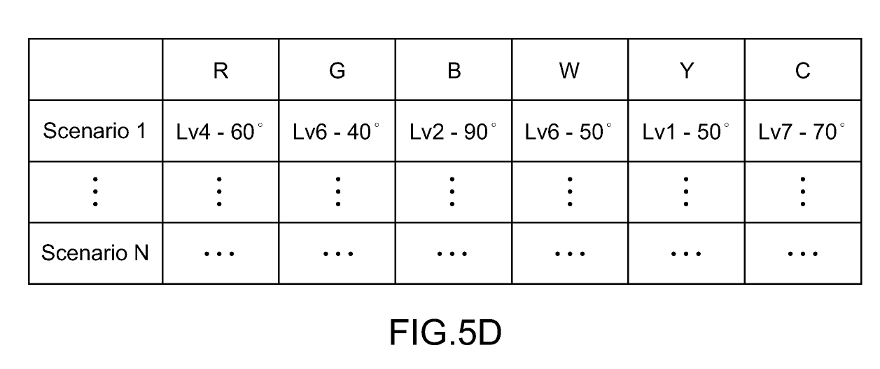

FIG. 5A is a look-up table correlating the light luminance levels to a set of relative power levels (in %). As shown in FIG. 5A, the light emitted by the light source has seven adjustable light luminance levels Lv1˜Lv7. Corresponding to the light luminance levels Lv1˜Lv7, the relative power levels ranged from 70% to 130% are outputted. FIG. 5B is a look-up table correlating the color parameters of an exemplary color wheel to three scenarios. In this embodiment, the color wheel has four color sections of white color (W), red color (R), green color (G) and blue color (B). The W, R, G and B sections have fan-shaped areas whose inner angles are respectively 40, 160, 100 and 60 degree in relation to the rotation axis. FIG. 5C is a schematic timing waveform diagram illustrating the SCI signals used in the scenarios 1, 2 and 3. In the scenarios 1, 2 and 3, the light luminance levels for different color sections are distinguished so as to achieve various light colors. It is noted that, however, those skilled in the art will readily observe that numerous modifications and alterations may be made while retaining the teachings of the invention. For example, if the number of color sections is increased and the angular allocation of the color wheel is changed, more kinds of variable light colors to comply with diversified scenarios. FIG. 5D is a look-up table correlating the color parameters of another exemplary color wheel to N kinds of scenarios. In this embodiment, the color wheel has six color sections of white color (W), red color (R), green color (G), blue color (B), yellow color (Y) and cyan color (C). The W, R, G, B, Y and C sections have fan-shaped areas whose inner angles are respectively 60, 40, 90, 50, 50, and 70 degree in relation to the rotation axis. By simply decoding the SCI signals, various light colors in different scenarios are achieved without the need of an additional hardware component.

From the above description, the luminance control method and the luminance control device of the present invention are capable of achieving various light colors in different scenarios by using a power control signal containing different numbers of pulses and a color wheel with different color sections. As a consequence, the designing flexibility is enhanced and the drawbacks encountered from the prior art are obviated.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A luminance control method for use with a projection system having a light source and a color wheel, the luminance control method comprising steps of:
issuing a power control signal to define a plurality of time segments in a cycle period, wherein luminance messages composed of different numbers of pulses are included in respective time segments;
reading out the luminance messages included in the respective time segments in receipt of the power control signal; and
adjusting luminance values of the light emitted by the light source to be projected to the color wheel according to the luminance messages.

2. The luminance control method according to claim 1 wherein the power control signal is a start control input signal.

3. The luminance control method according to claim 1 wherein the cycle period is equal to the duration when the color wheel rotates for one revolution.

4. The luminance control method according to claim 1 wherein the number of time segments is equal to or less than the number of color sections of the color wheel.

5. The luminance control method according to claim 1 wherein the luminance message included in a current time segment is encoded in a certain time interval of a previous time spot.

6. A luminance control device for use with a projection system having a light source and a color wheel, the luminance control device comprising:
a processing module for issuing a power control signal to define a plurality of time segments in a cycle period, wherein luminance messages composed of different numbers of pulses are included in respective time segments;
a power supply unit for powering the light source; and
a lamp driver electrically connected to the processing module and the power supply unit for reading out the luminance messages included in the respective time segments in receipt of the power control signal, wherein the power levels to be outputted from the lamp driver to the light source are adjusted according to the luminance messages, thereby adjusting luminance values of the light emitted by the light source to be projected to the color wheel.

7. The luminance control device according to claim 6 wherein the projection system is a digital light processing projection system and the processing module is a digital light processing module.

8. The luminance control device according to claim 6 wherein the power control signal is a start control input signal to be transmitted to the color wheel, wherein the lamp driver is synchronous with the color wheel according to the start control input signal.

9. The luminance control device according to claim 6 wherein the cycle period is equal to the duration when the color wheel rotates for one revolution.

10. The luminance control device according to claim 6 wherein the number of time segments is equal to or less than the number of color sections of the color wheel.

11. The luminance control device according to claim 6 wherein the luminance message included in a current time segment is encoded in a certain time interval of a previous time spot.
